(19) United States
(12) Patent Application Publication
(10) Pub. No.: US 2017/0208117 A1
(43) Pub. Date: Jul. 20, 2017

(54) PTP INTERACTION ASSOCIATION SYSTEM SUPPORTING CONNECTION BETWEEN PRINT PHOTOGRAPH ALBUM AND INTERNET

(71) Applicant: Yimwai YAU, Hong Kong (CN)

(72) Inventor: Yimwai YAU, Hong Kong (CN)

(21) Appl. No.: 15/309,181

(22) PCT Filed: May 4, 2015
(86) PCT No.: PCT/CN2015/078212

§ 371 Date: Feb. 6, 2017

(30) Foreign Application Priority Data
May 4, 2014 (CN) 201420234008.X
May 5, 2014 (CN) 201420237438.7
May 5, 2014 (CN) 201420237440.4
Sep. 5, 2014 (CN) 201420525002.8

(51) Int. Cl. H04L 29/08

(52) U.S. Cl. CPC H04L 67/06; H04L 67/12; H04W 4/008

(57) ABSTRACT

Invention relates to Internet of Things technology, particularly to PTP interactive interconnected system supporting a connection of a print photo album product with the Internet to provide technical support enabling achieved Internet Plus for traditional industry. The system comprises a communication terminal supporting the PTP interactive interconnected system, a URL electronic data device, a print photo album product and a numeric mark. A carrier of the print photo album is attached with the numeric mark; the communication terminal supports input of a numeric character corresponding to the numeric mark; and an operating system of the communication terminal receives an instruction from the numeric mark, calls out paired URL electronic data stored in the URL electronic data device, and sends a request to a back-end server after processing the paired URL electronic data, and the back-end server returns an electronic file associated with the URL electronic data according to the request.

### BACKGROUND OF THE INVENTION

1. Technical Field

The present invention relates to a kind of Internet of Things technology, and in particular to a PTP interactive interconnected system supporting a connection of a print photo album with the Internet to provide technical support enabling achieved Internet Plus for a traditional industry.

2. Description of Related Art

An advertising product based on traditional media is significantly behind that of electronic media in transmission capability, nevertheless, it is absolutely not the fact that “an ultimate form of mass media may replace any one of media such as traditional print media, traditional broadcasting, traditional television and traditional Internet”, as promoted by some people.

Information accessibility includes two major categories: one is network accessibility, and the construction of website accessibility falls under the category of network accessibility issues; and the other is electronics and information technology accessibility, which is to address seamless cross-media interconnection.

The Internet Society of China provides a definition as follows: information accessibility refers to any person (including the healthy, the disabled, the young and the old) under any circumstances being able to get access to and make use of information equally and conveniently without barriers.

If a smart phone is used to log on to the Internet for the information related to a print media product and get access to richer relevant data through extension, an association technology is a necessary condition that cannot be crossed out.

At present, it is a mainstream concept to enable offline and online connection for a plane media product with the solution of two-dimensional barcode/quick response code patterns in the market. Even though a mature product and industry chain has formed regarding the two-dimensional barcode/quick response code patterns, there are many restrictions on the technical use conditions in actual operation, and this refer to the following restrictions:
a smart phone can scan a two-dimensional barcode/quick response code pattern only after downloading an appropriate application;
the clarity of the two-dimensional barcode/quick response code pattern;
the light for scanning the two-dimensional barcode/quick response code pattern;
the distance for scanning the two-dimensional barcode/quick response code pattern;
the two-dimensional barcode/quick response code pattern is not uniform in size and its attachment may affect the aesthetic appearance of an advertising board;
with each two-dimensional barcode/quick response code pattern corresponding to one URL electronic data, there are numerous two-dimensional barcode/quick response code patterns present so as to meet the market demand, which can be expected to lead to chaos; and
the two-dimensional barcode/quick response code pattern is embedded into a screen picture of a video product or a webpage;
during actual operation, the time for an electronic screen to display the two-dimensional barcode/quick response code pattern is very short, and it is difficult for a user to conduct the operation;
in case of a non-high definition video image, the two-dimensional barcode/quick response code pattern is caused to distort and thus becomes unreadable; and
in case of wobbling public transportation, the two-dimensional barcode/quick response code pattern is very difficult to read.

It is particularly emphasized that the solution of two-dimensional barcode/quick response code patterns is less competent to address the connection involving an audio/video product (an audio information technology).

Today, science and technology have entered into the era of human-computer interaction. In the public places of major cities, with the convergence between mobile networks and fixed networks, information accessibility is a technical barrier that cannot be crossed out for accessing the Internet anytime anywhere through a smart phone and achieving the development goal of smart cities.

As an important part of the new generation of information technology, the Internet of Things has been widely applied to network convergence, and thus is also known as the third wave following computer and Internet, in the development of the information industry around the world.

First, the Internet of Things still takes Internet as its core and foundation, and it is a network extending and expanding based on the Internet; and second, the clients of the Internet of Things have extended and expanded among any items for information exchange and communication, that is, things are closely linked.

As the Internet of Things technology develops continuously, there is an inevitable development trend of deep convergence between traditional industries and Internet technologies.

Therefore, there is an urgent expectation from the market to meet the requirements anytime anywhere at will with an easier, faster and more efficient Internet of Things technology.

### BRIEF SUMMARY OF THE INVENTION

To achieve the object above, the present invention provides a PTP interactive interconnected system supporting a connection of a print photo album with the Internet, comprising a communication terminal product supporting the PTP interactive interconnected system, a URL electronic data device, a print photo album product and a numeric mark, wherein the communication terminal product supports a remote communication function; the communication terminal product supports a short distance communication function; and the URL electronic data device holds a URL electronic data combination; the print photo album product is a combination of a cover and data pages; a carrier of the print photo album product is attached with the numeric mark; the communication terminal product supports the input of a numeric character corresponding to the numeric mark; and an operating system of the communication terminal product receives an instruction from the numeric mark, calls out paired URL electronic data stored in the URL electronic data device, and sends a relevant request to a back-end server after processing the paired URL electronic data, and the back-end server returns an electronic file associated with the URL electronic data according to the relevant request.

The communication terminal product supports the remote communication function, and requests a connected telecommunication network to return an electronic file associated with the URL electronic data.

The communication terminal product supports WIFI (Wireless Fidelity) technology, and requests a connected WIFI device to return an electronic file associated with the URL electronic data.

The short distance communication function of the communication terminal product supports Bluetooth technology.

The short distance communication function of the communication terminal product supports a kind of NFC (Near Field Communication) technology.

The URL electronic data device consists of a built-in URL electronic data device and a trigger URL electronic data device.

The built-in URL electronic data device is equipped in the communication terminal product, and the built-in URL electronic data device stores an raw URL electronic data combination.

The trigger URL electronic data device is an external NFC product equipped in a print photo album product, activates the raw URL electronic data combination stored in the built-in URL electronic data device of the communication terminal product based on a contacting working state between the communication terminal product and the external NFC product, and transforms the raw URL electronic data combination into another new set of URL electronic data combination.

The numeric character of the numeric mark is correspondingly paired with the URL electronic data combination stored in the URL electronic data device 90.

The data pages are printed with page numbers and attached with different numeric marks; and data surface of the data pages are attached with stickable transparent pages (16).

The technology of the present invention is a PTP interactive interconnected system supporting the connection of a print photo album product with the Internet, and provides technical support enabling the deep convergence between traditional industries and Internet technologies, and achieved Internet Plus.

1. The technology of the present invention employs the URL electronic data of the international standard technology as a media technology for the interactive interconnected system, and the communication terminal product supports the input of the corresponding numeric character according to the numeric mark, truly enabling barrier-free connection.

2. With the simplest point to point connection technology, a new technical direction of solution is provided regarding the big data congestion problem confronted by the development of the Internet.

3. The URL electronic data stored in the URL electronic data device designed by the present invention is an raw URL electronic data combination, which may change as required through the functional support of the URL electronic data device, either meeting numerous user requirements in the market or preventing the chaos caused by the overlapping of numeric marks.

The present invention is obviously superior to the solution of two-dimensional barcode/quick response code patterns in the market and the relevant solutions of connection technologies in terms of both operation and effect, thereby meeting the vision of obtaining information anytime anywhere at will in the era of mobile information.

### BRIEF DESCRIPTION OF THE SEVERAL VIEWS OF THE DRAWINGS

FIG. 1 is a schematic diagram of a structure of a URL electronic data device;

FIG. 2A is a schematic diagram 1 of a working principle of the URL electronic data device;

FIG. 2B is a schematic diagram 2 of a working principle of the URL electronic data device;

FIG. 3A is a schematic diagram 1 of an example 1 of a print photo album product employing the technology of the present invention;

FIG. 3B is a schematic diagram 2 of an example 1 of the print photo album product employing the technology of the present invention;

FIG. 4A is a schematic diagram 1 of an example 2 of the print photo album product employing the technology of the present invention;

FIG. 4B is a schematic diagram 2 of an example 2 of the print photo album product employing the technology of the present invention;

FIG. 5A is a schematic diagram 1 of an exterior of the print photo album product employing the technology of the present invention;

FIG. 5B is a schematic diagram 2 of an application of the print photo album product employing the technology of the present invention.

### DETAILED DESCRIPTION OF THE INVENTION

The following embodiments are intended to further explain and illustrate the present invention, instead of setting any limit to the present invention.

The present invention provides a PTP interactive interconnected system supporting a connection of a print photo album product with the Internet, comprising a communication terminal product 38 supporting the PTP interactive interconnected system, a URL electronic data device 90, a print photo album product 100 and a numeric mark, wherein the communication terminal product supports a remote communication function; the communication terminal product supports a short distance communication function; and the URL electronic data device 90 stores a URL electronic data combination; the print photo album product is a combination of a cover 10 and data pages 14; a carrier of the print photo album product is attached with the numeric mark; the communication terminal product supports the input of a numeric character corresponding to the numeric mark; and an operating system of the communication terminal product receives an instruction from the numeric mark, calls out paired URL electronic data stored in the URL electronic data device 90, and sends a relevant request to a back-end server after processing the paired URL electronic data, and the back-end server returns an electronic file associated with the URL electronic data according to the relevant request.

The communication terminal product supports the remote communication function, and requests a connected telecommunication network to return an electronic file associated with the URL electronic data.

The communication terminal product supports WIFI (Wireless Fidelity) technology, and requests a connected WIFI device to return an electronic file associated with the URL electronic data.

The returned electronic file is browsed through a display screen of the communication terminal product.

The short distance communication function of the communication terminal product supports Bluetooth technology, and obtains the URL electronic data from a relevant external product.

The short distance communication function of the communication terminal product supports a kind of NFC (Near Field Communication) technology, and obtains the URL electronic data from an external NFC product.

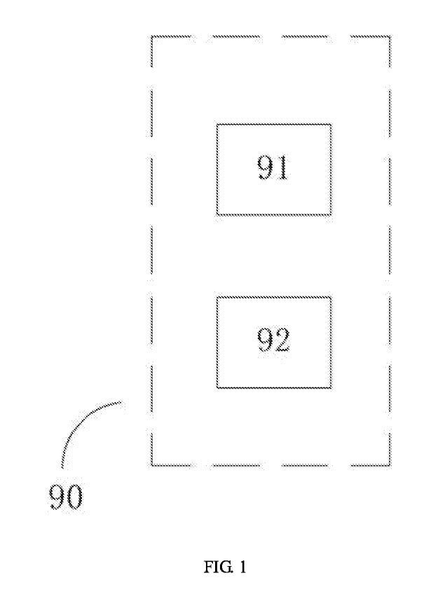

The URL electronic data device 90 consists of a built-in URL electronic data device 91 and an trigger URL electronic data device 92, as shown in FIG. 1A.

The built-in URL electronic data device is equipped in the communication terminal product, the built-in URL electronic data device stores an original URL electronic data combination.

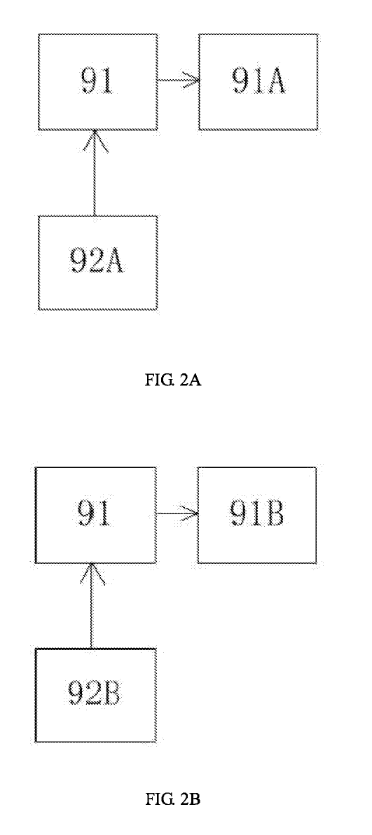

As shown in FIG. 2 in series, the trigger URL electronic data device is an external NFC product 95 equipped in a print photo album product. The trigger URL electronic data device activates the raw URL electronic data combination stored in the built-in URL electronic data device 91 of the communication terminal product based on a contacting working state between the communication terminal product and the external NFC product 95, and transforms the raw URL electronic data combination into another new set of URL electronic data combination.

Not only can numerous user requirements in the market be met, but also the chaos caused by the overlapping of numeric marks is prevented.

As shown in FIG. 2A, a design solution of the present embodiment is as follows: the raw URL electronic data combination of the built-in URL electronic data device 91 is a series of “0000+(0001˜9999)”; the trigger URL electronic data device 92A has the URL electronic data of “0001”, activates the raw URL electronic data combination stored in the built-in URL electronic data device 91 of the communication terminal product and transforms the raw URL electronic data combination into another new set of URL electronic data combination; and the raw URL electronic data combination is transformed from the series of “0000+(0001˜9999)” into the series of “0001+(0001˜9999)”.

As shown in FIG. 2B, a design solution of the present embodiment is as follows: the raw URL electronic data combination of the built-in URL electronic data device 91 is a series of 0000+(0001˜9999); the trigger URL electronic data device 92B has the URL electronic data of “0033”, activates the raw URL electronic data combination stored in the built-in URL electronic data device 91 of the communication terminal product and transforms the raw URL electronic data combination into another new set of URL electronic data combination; and the raw URL electronic data combination is transformed from the series of 0000+(0001˜9999) into the series of 0033+(0001˜9999).

The numeric character of the numeric mark is correspondingly paired with the URL electronic data combination stored in the URL electronic data device 90.

The numeric mark may be from different sources, including traditional paper-made newspapers and periodicals, paper-made books, advertising boards of print media, traffic boards on public roads, publication and guide boards for public tourism, guide boards for emergency services, public bus shelters, taxi call service shelters, bank logos and the like.

URL electronic data links are sourced from various aspects, including memory, cloud storage, webpages based on login settings and the like, and the relevant technologies will not be explained herein in detail any more since they are extremely conventional and common in the market.

To improve the transmission effect of traditional media products, there have been different technical solutions in the market, including the solution of two-dimensional barcode/quick response code patterns, the solution of NFC technology and the solution of RFID technology and the like.

Relevant technical solutions and the application of the technology of the present invention are compared as follows:
a traditional print photo has no electronic data for any electronic reading product to read, and it is a personal arbitrary behavior for people to store a print photo; and if the print photo is made with a special method, the purpose of directly reading the electronic data can be achieved but at very high cost and with great limitation in usage, which is not in conformity with the requirement on popularization in the market.

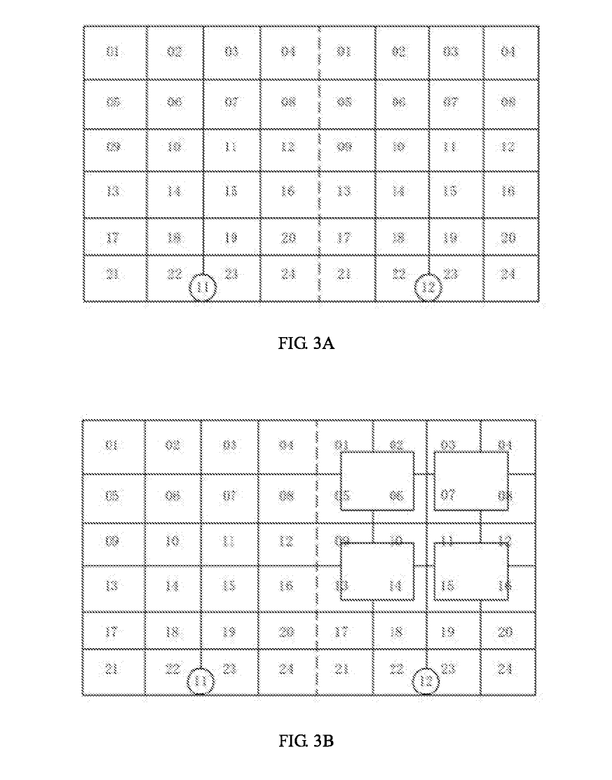

The data pages are printed with page numbers and attached with different numeric marks; and as shown in FIG. 3A, the data pages are printed with Page 11 and Page 12 and are respectively divided into 24 areas, with different areas attached with different numeric character groups; and the surfaces of the data pages are attached with stickable transparent sheets 16, which are used for covering after the print photo is well placed to achieve the effect of stabilization.

As shown in FIG. 3B, in the present embodiment, there are four print photos placed on Page 12 of the data pages, and setting of a print mark and establishing of an electronic document are respectively performed for the print photos; to be specific, it is assumed that the positions at which the print photos are placed are taken as a reference basis; the print photo A is set as 1202; the print photo B is set as 1204; the print photo C is set as 1210; the print photo D is set as 1212; and a user may set a link to data (live recording, incidental music and the like) related to the background of the print photos in the new electronic document according to personal interests or requirements.

Afterwards, when relevant print photos are referred to, the communication terminal product supports the input of the numeric character corresponding to the numeric mark; and if the user wants to change the print photo, he/she needs to eliminate the address of the established electronic document, places other print photos again and repeats the operation above, achieving the goal of arbitrarily placing the print photos.

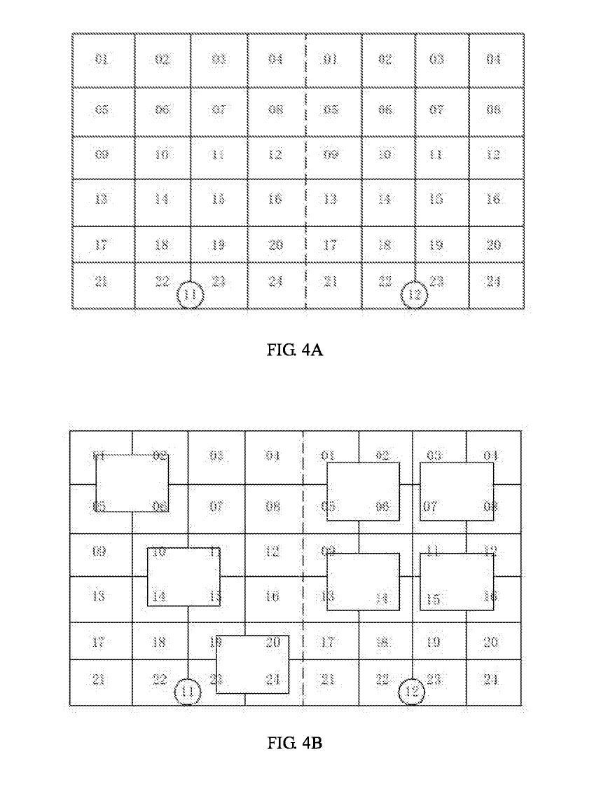

With reference to FIGS. 4A and 3A, the attachment of the numeric mark is likewise completed; and as shown in FIG. 4B, the placement of the print photo on Page 12 of the data pages is the same as that completed in FIG. 3B, so is the numeric mark; and it is particularly indicated that the above is based on that the trigger URL electronic data device is an external NFC product 95 equipped in the print data album product, activates the raw URL electronic data combination stored in the built-in URL electronic data device 91 of the communication terminal product based on a contacting working state between the communication terminal product and the external NFC product 95, and transforms the raw URL electronic data combination into another new set of URL electronic data combination, therefore, the electronic file linked thereto may be different.

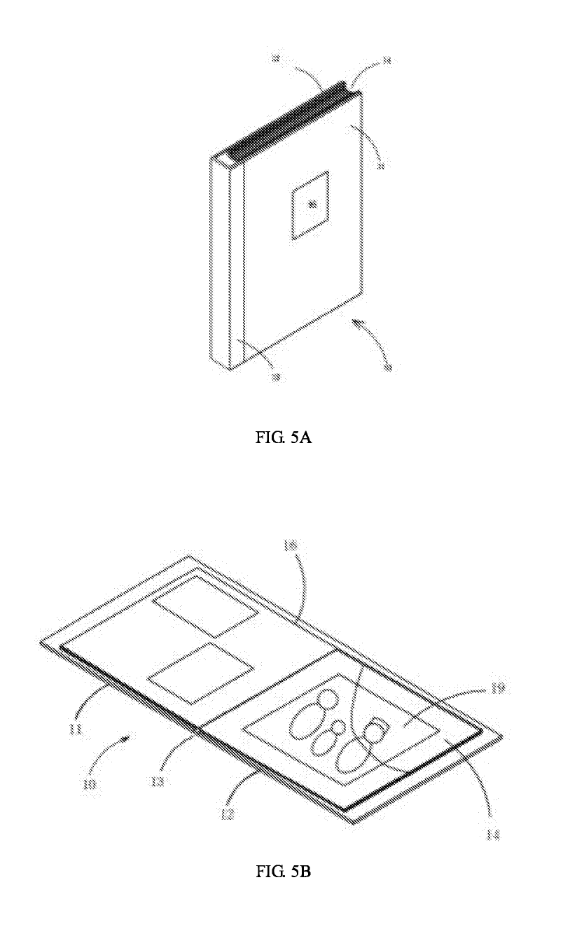

As shown in FIG. 5A, there is provided a diagram showing an exterior of the print photo album product, and as shown in FIG. 5B, there is provided a schematic diagram showing the operation of placing the print photo according to the technology of the present invention.

The technology of the present invention provides a technical solution having a category different from that of the solution of two-dimensional barcode/quick response code patterns, and thus has distinct effects as follows:
1. basically no limit from distance;
2. basically no impact from light conditions;
3. accuracy superior to that of the solution of two-dimensional code patterns; and
4. fewer impacts to the aesthetic appearance of an advertising board due to substitution of the two-dimensional barcode/quick response code pattern with the numeric character.

With reference to the effects of the relevant embodiments above, the technology of the present invention is obviously superior in terms of operation, fabrication cost and transmission effect compared with relevant technical solutions and product solutions in the market, and the technology of the present invention will be further developed to affect all the links of a commercial chain and create a brand-new form of commercial mode and value chain.

Though the technology of the present invention is disclosed with the embodiments above, the scope of the technology of the present invention is not limited thereto, and all the components above may be substituted with other similar or equivalent elements known to those skilled in the art without departing from the conception of the technology of the present invention.

1. A PTP interactive interconnected system supporting a connection of a print photo album product with the Internet, comprising a communication terminal product supporting the PTP interactive interconnected system, a URL electronic data device, a print photo album product and a numeric mark, wherein
the communication terminal product supports a remote communication function;
the communication terminal product supports a short distance communication function; and
the URL electronic data device stores a URL electronic data combination;
the print photo album product is a combination of a cover and data pages;
a carrier of the print photo album product is attached with the numeric mark;
the communication terminal product supports the input of a numeric character corresponding to the numeric mark; and
an operating system of the communication terminal product receives an instruction from the numeric mark, calls out paired URL electronic data stored in the URL electronic data device, and sends a relevant request to a back-end server after processing the paired URL electronic data, and the back-end server returns an electronic file associated with the URL electronic data according to the relevant request.

2. The PTP interactive interconnected system supporting the connection of the print photo album product with the Internet of claim 1, wherein the communication terminal product supports the remote communication function, and requests a connected telecommunication network to return an electronic file associated with the URL electronic data.

3. The PTP interactive interconnected system supporting the connection of the print photo album product with the Internet of claim 1, wherein the communication terminal product supports WIFI (Wireless Fidelity) technology, and requests a connected WIFI device to return an electronic file associated with the URL electronic data.

4. The PTP interactive interconnected system supporting the connection of the print photo album product with the Internet of claim 1, wherein the short distance communication function of the communication terminal product supports Bluetooth technology.

5. The PTP interactive interconnected system supporting the connection of the print photo album product with the Internet of claim 1, wherein the short distance communication function of the communication terminal product supports a kind of NFC (Near Field Communication) technology.

6. The PTP interactive interconnected system supporting the connection of the pint photo album product with the Internet of claim 1, wherein the URL electronic data device consists of a built-in URL electronic data device and a trigger URL electronic data device.

7. The PTP interactive interconnected system supporting the connection of the print photo album product with the Internet of claim 6, wherein the built-in URL electronic data device is equipped in the communication terminal product, and the built-in URL electronic data device stores an raw URL electronic data combination.

8. The PTP interactive interconnected system supporting the connection of the print photo album product with the Internet of claim 6, wherein the trigger URL electronic data device is an external NFC product equipped in a print photo album product, activates the raw URL electronic data combination stored in the built-in URL electronic data device of the communication terminal product based on a contacting working state between the communication terminal product and the external NFC product, and transforms the raw URL electronic data combination into another new set of URL electronic data combination.

9. The PTP interactive interconnected system supporting the connection of the print photo album product with the Internet of claim 1, wherein the numeric character of the numeric mark is correspondingly paired with the URL electronic data combination stored in the URL electronic data device.

10. The PTP interactive interconnected system supporting the connection of the print photo album product with the Internet of claim 1, wherein the data pages are printed with page numbers and attached with different numeric marks; and data surface of the data pages are attached with stickable transparent pages.
